(19) United States
(12) Patent Application Publication
(10) Pub. No.: US 2013/0177117 A1
(43) Pub. Date: Jul. 11, 2013

(54) APPARATUS FOR GENERATING A NEUTRON FLUX FROM A PLURALITY OF NEUTRON SOURCES

(71) Applicant: Jameel Abdulkader Hefne, Riyadh (SA)

(72) Inventor: Jameel Abdulkader Hefne, Riyadh (SA)

(73) Assignee: King Abdul Aziz City for Science and Technology, Riyadh (SA)

(21) Appl. No.: 13/348,638

(22) Filed: Jan. 11, 2012

(51) Int. Cl. H05H 6/00; G21C 5/00; G21K 5/08; G21C 19/00; H05H 3/06; G21B 1/00

(52) U.S. Cl. 376/110; 376/114

(57) ABSTRACT

The present invention provides an apparatus for generating a neutron flux using a plurality of neutron sources. The apparatus comprises a cylindrical holder for holding the plurality of neutron sources, a cylindrical moderator unit for holding a sample material and comprising of neutron moderator material. The apparatus further comprises a housing unit for housing the cylindrical holder and the cylindrical moderator unit. A releasing unit is coupled to the housing unit and connected to the cylindrical moderator unit for positioning a portion of the cylindrical moderator unit within the cylindrical holder. The sample material is irradiated with neutron flux generated.

### FIELD OF THE INVENTION

The present invention generally relates to generating a neutron flux using a plurality of neutron sources, and more specifically to an apparatus for maximizing the neutron flux using the plurality of neutron sources.

### BACKGROUND OF THE INVENTION

A neutron is a sub-atomic particle having no electric charge and a mass higher than that of a proton. A neutron flux may be generated using neutron sources. The neutron flux may be used in many applications including, but not limited to, Neutron Activation Analysis (NAA) for determining concentrations of elements in a sample material, generation of nuclear power and Prompt Gamma Neutron Activation Analysis (PGNAA). There are three broad categories of neutron sources that generate neutron flux namely, isotropic neutron sources, nuclear reactors and neutron generators. The isotropic neutron sources may include a combination of materials such as, but not limited to, Plutonium-Beryllium (PuBe), Americium-Beryllium (AmBe) and Americium-Lithium (AmLi).

These neutron sources are used in nuclear reactors and nuclear generators to generate neutron flux for various applications. The isotropic neutron sources are small devices as compared to the nuclear reactors and the nuclear generators. Further, these nuclear reactors and nuclear generators are specifically used for generating specific type of neutron flux. A fast nuclear reactor generates a fast neutron flux whereas a thermal nuclear reactor generates a thermal neutron flux. The fast neutron flux is created by generation of fast neutrons whereas the thermal neutron flux is created by generation of thermal neutrons. These nuclear reactors may be used for various applications, but not limited to, generating a large neutron flux, generating electricity and propulsion of ships. The nuclear reactors have certain disadvantages including, but not limited to, bulkiness, expensive, lack of effective protection against radiation, nuclear waste disposal problems, lack of effective protection against radiation and samples used in the nuclear reactors have a shorter life period.

Therefore there is a need for an apparatus for generating a neutron flux in a convenient manner.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an exemplary representation of an apparatus for generating a neutron flux in accordance with various embodiments of the present invention.

FIG. 2 illustrates a cylindrical holder for holding a plurality of neutron sources in accordance with an embodiment of the invention.

FIG. 3 illustrates a cylindrical moderator unit for holding a neutron moderator material and a sample material in accordance with an embodiment of the invention.

FIG. 4 illustrates a cylindrical holder and a cylindrical moderator unit enclosed within a housing unit in accordance with an embodiment of the invention.

FIG. 5 illustrates a cylindrical holder and a cylindrical moderator unit enclosed within a housing unit in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to an apparatus for generating a neutron flux using a plurality of neutron sources. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, or apparatus that comprises the element.

Various embodiments of the invention provide an apparatus for generating a neutron flux using a plurality of neutron sources. The apparatus comprises a cylindrical holder, a cylindrical moderator unit and a housing unit. The cylindrical holder holds the plurality of neutron sources. The cylindrical moderator unit holds a sample material and comprises of a neutron moderator material. A portion of the cylindrical moderator unit is received within the cylindrical holder. Subsequently the sample material is irradiated using the neutron flux generated by the plurality of neutrons. The housing unit houses the cylindrical holder and the cylindrical moderator unit. The housing unit comprises a neutron shielding material. The neutron shielding material reflects a plurality of neutrons generated by the plurality of neutron sources within the housing unit.

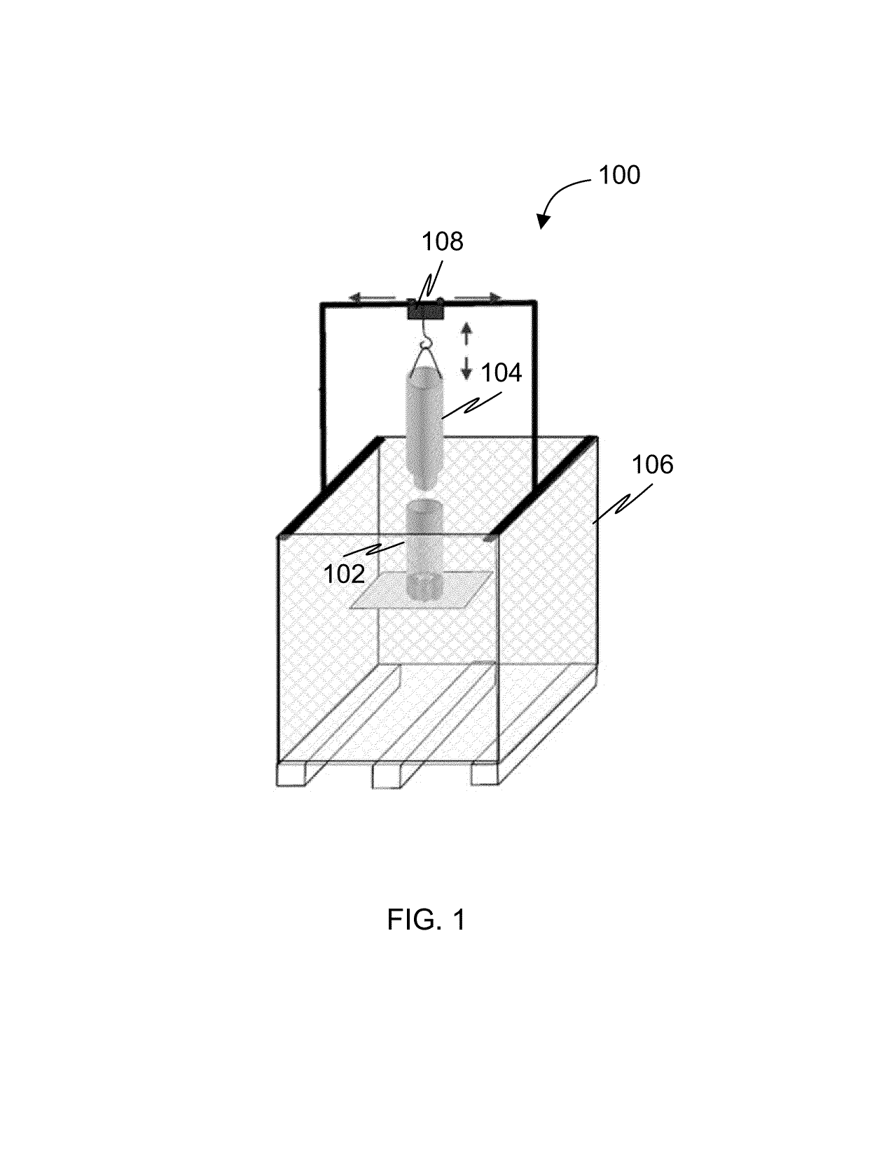

Referring to the drawings and in particular to FIG. 1, an exemplary representation of an apparatus 100 for generating a neutron flux using a plurality of neutron sources is shown, in accordance with various embodiments of the invention. The neutron flux generated may be used in many applications including, but not limited to, Neutron Activation Analysis (NAA) for determining concentrations of various elements in a sample material, generation of nuclear power and Prompt Gamma Neutron Activation Analysis (PGNAA). Apparatus 100 comprises a cylindrical holder 102, a cylindrical moderator unit 104 and a housing unit 106.

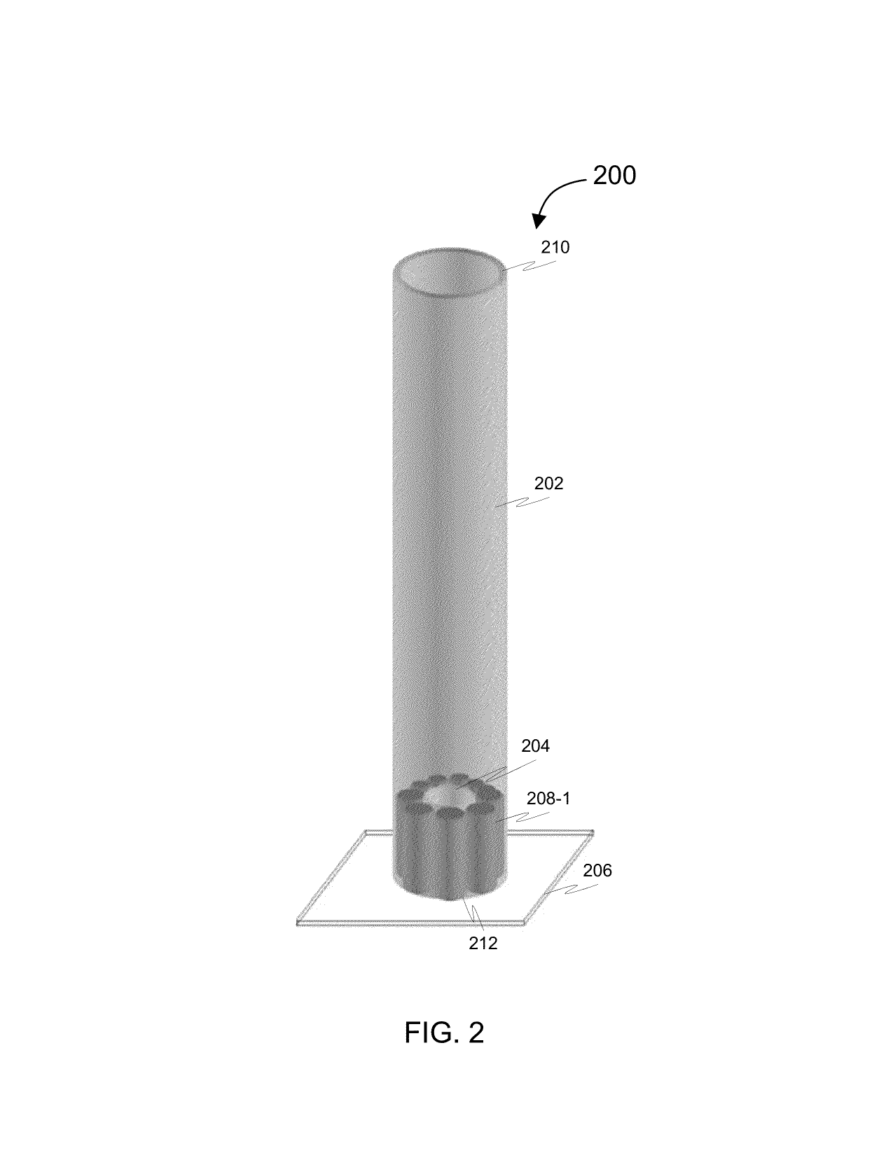

Cylindrical holder 102 is used for holding a plurality of neutron sources. The plurality of neutron sources may include such as, but not limited to, Plutonium-Beryllium (PuBe), Americium-Beryllium (AmBe) and Americium-Lithium (AmLi). In an embodiment, the plurality of neutron sources may be arranged in a particular manner as described in a detail in conjunction with FIG. 2. Cylindrical holder 102 may have different shapes including, but not limited to, square, rectangle and polygon.

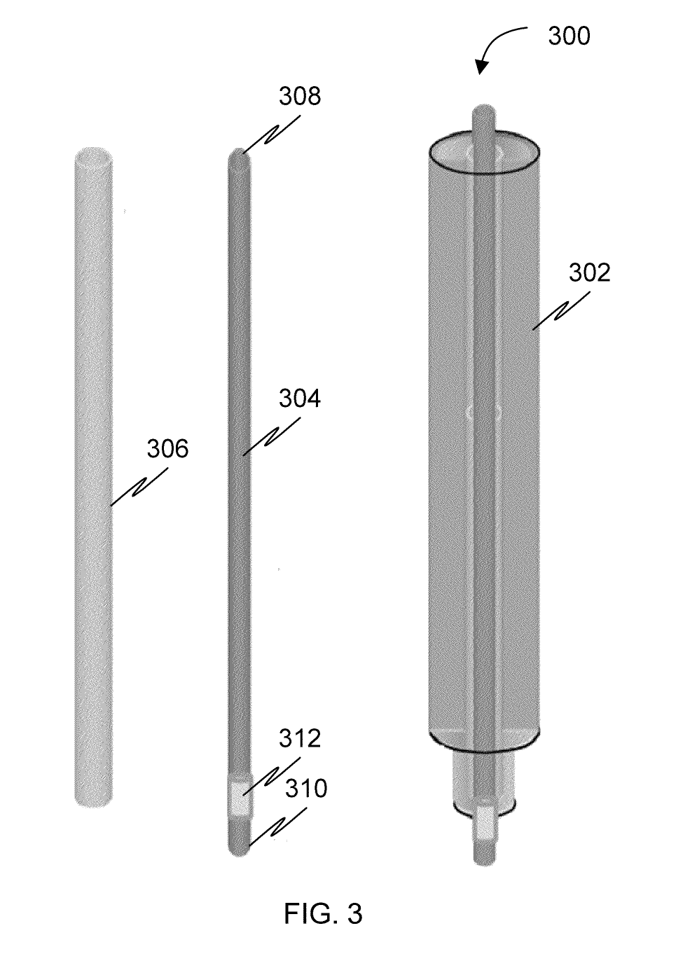

Cylindrical moderator unit 104 holds a sample material and a neutron moderator material. The sample material may be, but not limited to, any element known in the art. The neutron moderator material may include, but are not limited to, a wax, water, paraffin, ZiH₂, BeH₂ and TiH₂. The neutron moderator material may be filled within cylindrical moderator unit 104 in a manner that it is isolated from the sample material. This is explained in detail in conjunction with FIG. 3. Cylindrical moderator unit 106 may have different shapes including, but are not limited to, rectangle, square and polygon.

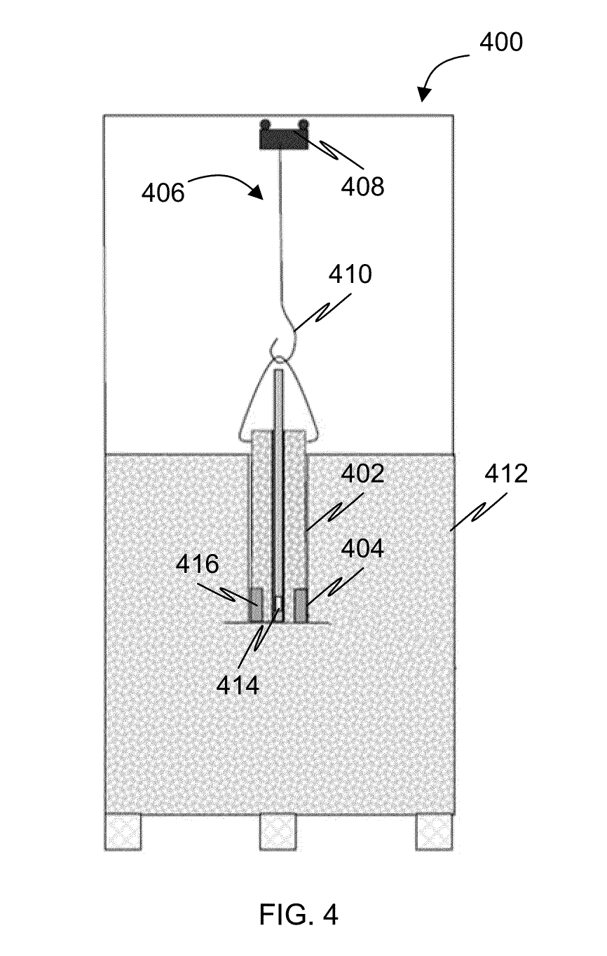

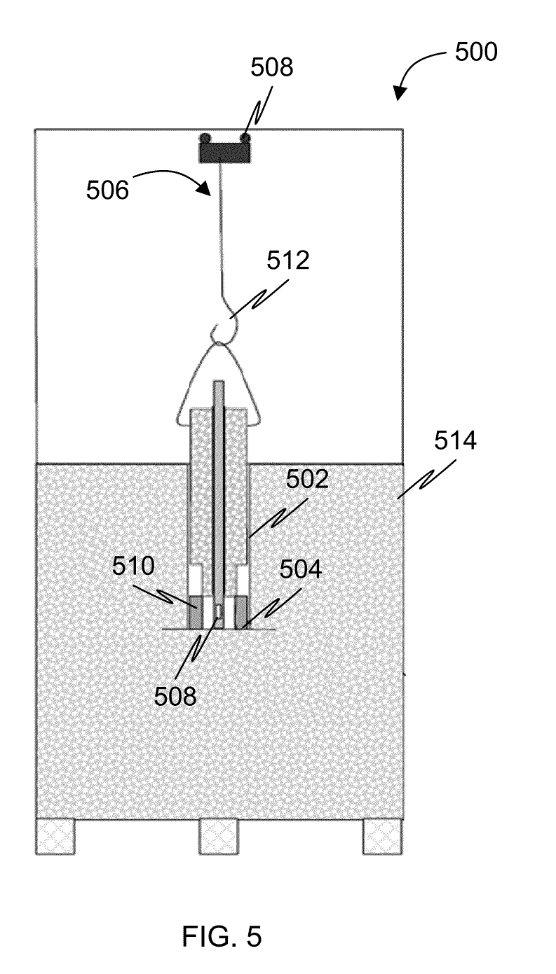

A portion of cylindrical moderator unit 104 may be received within cylindrical holder 102. Subsequently, the neutron moderator material comes in contact with the plurality of the neutron sources. Then, a plurality of neutrons is generated that creates a neutron flux. The neutron flux created may be, but not limited to, a fast neutron flux and a thermal neutron flux. The fast neutron flux is generated by the plurality of neutron sources devoid of the neutron moderator material. The thermal neutron flux is generated by the plurality of neutron sources upon coming in contact with the neutron moderator material. Thus, the neutron flux generated may depend on the portion of cylindrical moderator unit 104 received within cylindrical holder 102. This is explained in detail in conjunction with FIG. 4 and FIG. 5.

Cylindrical holder 102 and cylindrical moderator unit 104 is housed within housing unit 106. Cylindrical moderator unit 104 and cylindrical holder 102 needs to be supported when housed within housing unit 106. Thus apparatus 100 comprises a base member 108 supporting cylindrical holder 102 at an end of cylindrical holder 102. The base member may be positioned within housing unit 106 using any arrangement known in the art. Housing unit 106 may be filled with a neutron shielding material. The neutron shielding material may include, but are not limited to, a wax, water, paraffin, Boron Carbide (B₄C) and epoxy resin. In an embodiment, the neutron shielding material may prevent the plurality of neutrons from going out of housing unit 106. The neutron shielding material reflects the plurality of neutrons within housing unit 106 thereby preventing loss of the plurality of neutrons. In this case, in an embodiment the neutron material once filled up to a portion of housing unit 106, base member 108 may be placed within housing unit 106 and thereafter remaining portion of housing unit 106 may be filled with the neutron material. The neutron material may be filled in the remaining portion after placing cylindrical holder 102. Housing unit 106 is composed of, but are not limited to, iron, steel and aluminum. Housing unit 106 may have different configuration such as, but not limited to, a cubical box, a square box, a rectangular box and a polygon box.

In an embodiment, a housing unit such as, housing unit 106 may be a cubical box. In this case, the housing unit may have a length of 115 cm and height 120 cm. However the housing unit may have any other dimensions that render the apparatus such as, apparatus 100 to be compact and functional for generating a neutron flux with maximum efficiency.

Now during operation of apparatus 100, a portion of cylindrical moderator unit 104 may need to be placed within cylindrical holder 102 as explained earlier. Thus a releasing unit 108 connected to cylindrical moderator unit 104 may be used to release cylindrical moderator unit 104 closer to cylindrical holder 102 for having the portion of cylindrical moderator unit 104 received within cylindrical holder 102. Releasing unit 108 is coupled to housing unit 106 as illustrated in FIG. 1. Examples of releasing unit 108 may include, but not limited to, a craned hand, a pulley arrangement, a roller-type block and a feed wheel arrangement. In an embodiment, a releasing unit such as, releasing unit 108 may be a lifting unit. The lifting unit may be made up of, but not limited to, steel, plastic and any metal known in the art. The lifting unit may be coupled to a hook arrangement. The hook arrangement may be connected to a pulley arrangement connected to a housing unit such as, housing unit 106. The pulley arrangement may comprise of a belt or a chain facilitating pulling and pushing a cylindrical moderator unit such as, cylindrical moderator unit 104.

In an embodiment, a releasing unit such as, releasing unit 108 may have a height of 160 cm. However the releasing unit may have any other dimensions that render the releasing unit to conveniently hold and release cylindrical moderator unit 104 closer to cylindrical holder 102. Thereafter a neutron flux is created within cylindrical holder 102. Then, the sample material is irradiated with the neutron flux created. Releasing unit 108 may be also capable of retrieving back cylindrical moderator unit 104 from cylindrical holder 102.

FIG. 2 illustrates a cylindrical holder 200 in accordance an embodiment of the invention. Cylindrical holder 200 comprises an outer cylinder 202, an inner cylinder 204. A base member 206 may be provided as a support to cylindrical holder 200 which is explained in detail later in FIG. 2. Cylindrical holder 200 is composed of, but not limited to, steel, iron and aluminum. Outer cylinder 202 surrounds inner cylinder 204. In an embodiment outer cylinder 202 and inner cylinder 204 may have a common center. Outer cylinder 202 and inner cylinder 204 may have different shapes including, but not limited to, cylinder, square, rectangle and polygon. Outer cylinder 202 holds a plurality of neutron sources 208-n. In an embodiment, a plurality of neutron sources 208-n may be positioned around a periphery of inner cylinder 204 within outer cylinder 202. For example, a neutron source 208-1 is placed proximal to the periphery of inner cylinder 204. However a plurality of neutron sources such as, plurality of neutron sources 208-n may be placed in any other fashion within cylindrical holder 200.

In an embodiment, inner cylinder 204 may have dimensions lesser than outer cylinder 202. A cylindrical holder such as, cylindrical holder 200 may have an outer cylinder with a diameter of 18.52 cm, length of 65 cm. Further an inner cylinder may have a diameter of 10.08 cm and a length of 12 cm. A gap of 4.1 cm may be provided between the outer cylinder and the inner cylinder. Thus the cylindrical holder such as, cylindrical holder 200 may have smaller dimensions that render apparatus 100 to be compact, light weight and less bulky as compared to the existing nuclear reactors and neutron generators. However the cylindrical holder may have any other dimensions that render the apparatus such as, apparatus 100 to be compact and functional for generating a neutron flux with maximum efficiency.

In another embodiment, a cylindrical holder such as, cylindrical holder 200 may have an outer cylinder and an inner cylinder open at first end 210 and closed at second end 212. Then, a base member such as, base member 206 supports the cylindrical holder at second end 212. In yet another embodiment, a cylindrical holder such as, cylindrical holder 200 may have an outer cylinder and an inner cylinder open at both first end 210 and at second end 212. Then, a base member such as, base member 206 may prevent a plurality of neutron sources from falling out of cylindrical holder 200. Base member 206 may be composed of, but not limited to, steel, iron, aluminum and wood. Base member 206 may have different shapes such as, but not limited to, square, rectangle, circular and any other shape.

FIG. 3 illustrates a cylindrical moderator unit 300 in accordance with an embodiment of the invention. Cylindrical moderator unit 300 comprises a first cylindrical unit 302 and a second cylindrical unit 304. First cylindrical unit 302 and second cylindrical unit 304 may have different shapes including, but not limited to, cylindrical, square, rectangle and any polygon with a common center. First cylindrical unit 302 comprises a neutron moderator material. For example, first cylindrical unit 302 may be filled with a neutron moderator material. The neutron moderator material may include, but not limited to, a wax, water, paraffin, ZiH₂, BeH₂ and TiH₂. Further, first cylindrical unit 302 may be composed of, but not limited to, steel, iron and aluminum.

Second cylindrical unit 304 is positioned within first cylindrical unit 302. In an embodiment, second cylindrical unit 304 may be open at a first end 308 and closed at a second end 310. Second cylindrical unit 304 holds a sample material 312 proximal to second end 310. In an embodiment, a second cylindrical unit such as, second cylindrical unit 304 includes an opening for facilitating feeding of the sample material into the second cylindrical unit. The opening may be, but not limited to, top, bottom and center of the second cylindrical unit. The opening may be coupled to the second cylindrical unit using any coupling mechanism known in the art. The sample material is explained in conjunction with FIG. 1. Second end 310 may protrude out of first cylindrical unit 302 when second cylindrical unit 304 is placed within first cylindrical unit 302. In an embodiment, both first end 308 and second end 310 of second cylindrical unit 304 may protrude out of first cylindrical unit 302. Further, second cylindrical unit 304 may be composed of, but not limited to, polyethylene which may avoid any activation due to a long radiation time. In an embodiment, a second cylindrical unit may be filled with neutron moderator material until a position where a sample material is placed.

In another embodiment, a third cylindrical unit 306 may be positioned surrounding second cylindrical unit 304 and positioned within first cylindrical unit 302. Third cylindrical unit 306 may be composed of, but not limited to, plastic, steel and iron. When third cylindrical unit 306 is positioned within first cylindrical unit 302, the neutron moderator material positioned within first cylindrical unit 302 comes in contact with an outer surface of third cylindrical unit 306. Thus, third cylindrical unit 306 prevents the sample material present in second cylindrical unit 304 from coming in contact with the neutron moderator material. Due to this arrangement of cylindrical moderator unit 300, second cylindrical unit 304 may freely move within third cylindrical unit 306. In an embodiment, cylindrical moderator unit 300 may include a holder that may hold second cylindrical unit 304 and facilitate second cylindrical unit 304 to move within third cylindrical unit 306.

In another embodiment, a cylindrical moderator unit such as, cylindrical moderator unit 300 may comprise a first cylindrical unit having a diameter of 18.08 cm and a length of 60 cm. The second cylindrical unit present in the cylindrical moderator unit may have a length of 82 cm. Further a third cylindrical unit positioned surrounding the second cylindrical unit may have a length of 72 cm. However the cylindrical moderator unit may have any other dimensions that render the apparatus such as, apparatus 100 to be compact and functional for generating a neutron flux with maximum efficiency.

FIG. 4 illustrates a cross-sectional view of an apparatus 400 having a cylindrical moderator unit 402 positioned within a cylindrical holder 404 using a releasing unit 406 in accordance with an embodiment of the invention. In an embodiment, releasing unit 406 may be a pulley unit 408. Cylindrical moderator unit 402 may be disengagably connected to pulley unit 408 using a hook arrangement 410. Further, pulley unit 408 may be coupled to a housing unit 412. Housing unit 412 houses cylindrical moderator unit 402 and cylindrical holder 404. Housing unit 412 comprises a neutron shielding material. The neutron shielding material may be filled within housing unit 412 and surrounds cylindrical moderator unit 402 and cylindrical holder 404 as illustrated in FIG. 4. Cylindrical moderator unit 402 comprises a first cylindrical unit and a second cylindrical unit. The first cylindrical unit and the second cylindrical unit are not numbered in FIG. 4 for sake of convenience of representation. The first cylindrical unit and the second cylindrical unit may be arranged in any manner as explained in conjunction with FIG. 3. Cylindrical holder 404 comprises an outer cylinder and an inner cylinder. The outer cylinder and the inner cylinder may be arranged in any manner as explained in conjunction with FIG. 2.

Now referring back to releasing unit 406, releasing unit 406 is used for releasing cylindrical moderator unit 402 for having a portion of cylindrical moderator unit 402 within cylindrical holder 404. Also, releasing unit 406 is used for pulling a portion of cylindrical moderator unit 402 out of cylindrical holder 404.

In an embodiment, once cylindrical moderator unit 402 is released, a portion of the first cylindrical unit and the second cylindrical unit of cylindrical moderator unit 402 may be received within the inner cylinder of cylindrical holder 404. Thus neutron moderator material present inside the first cylindrical unit and a sample material 414 positioned inside the second cylindrical unit are positioned proximal to a plurality of neutron sources such as, a neutron source 416 as illustrated in FIG. 4. Thereafter the plurality of neutrons is generated by the plurality of neutron sources. The plurality of neutrons generated comprises a plurality of fast neutrons and a plurality of thermal neutrons. The neutron moderator material positioned inside the second cylindrical unit may moderate most of the plurality of fast neutrons and convert them into the plurality of thermal neutrons when exposed to the neutron moderator material. The plurality of neutrons that come out of cylindrical moderator unit 402 and cylindrical holder 404 may be reflected by the neutron shielding material positioned inside housing unit 412. As a result the plurality of neutrons is confined within housing unit 412 thereby maximizing a neutron flux for example, thermal neutron flux generated.

FIG. 5 illustrates a cross-sectional view of an apparatus 500 having a cylindrical moderator unit 502 being positioned within a cylindrical holder 504 using a releasing unit 506 in accordance with an embodiment of the invention. The arrangement of cylindrical moderator unit 502, cylindrical holder 504 and releasing unit 506 is explained in detail in conjunction with FIG. 2, FIG. 3 and FIG. 4.

In an embodiment, once cylindrical moderator unit 502 is released, a portion of the second cylindrical unit of cylindrical moderator unit 502 may be received within the inner cylinder of cylindrical holder 504. Thus a sample material 508 positioned inside the second cylindrical unit is positioned proximal to a plurality of neutron sources such as, neutron source 510 as illustrated in FIG. 5. In this case, the first cylindrical unit of cylindrical moderator unit 502 may not be received within the inner cylinder of cylindrical holder 504. The first cylindrical unit may be held up by releasing unit 506 through a hook arrangement 512 as illustrated in FIG. 5. The plurality of neutrons is then generated by the plurality of neutron sources. The plurality of neutrons generated comprises a plurality of fast neutrons because of the absence of a portion of the first cylindrical unit within the inner cylinder. The plurality of fast neutrons is generated due to the absence of the neutron moderator material present in the first cylindrical unit. The plurality of neutrons that come out of cylindrical moderator unit 502 and cylindrical holder 504 may be reflected by the neutron shielding material positioned inside housing unit 514. As a result the plurality of neutrons is confined within housing unit 514 thereby maximizing a neutron flux for example, thermal neutron flux generated. Subsequently, the sample material positioned inside the second cylindrical unit may be irradiated using the plurality of neutrons generated.

Various embodiments of the present invention provide an apparatus for generating a neutron flux using a plurality of neutron sources. The apparatus may provide effective shielding against radiations emitted from the plurality of neutron sources. Also, the apparatus may utilize the plurality of neutron sources simultaneously within the same apparatus. Further, the arrangement of a cylindrical moderator unit and a cylindrical holder within the apparatus facilitates in conversion of a large amount of fast neutron flux into thermal neutron flux thereby maximizing a neutron flux generated within the apparatus. Additionally, a sample material used in the apparatus has a longer life compared to existing nuclear reactors and neutron generators. Furthermore, the apparatus of the present invention is inexpensive and compact compared to the existing nuclear reactors and neutron generators.

Those skilled in the art will realize that the above recognized advantages and other advantages described herein are merely exemplary and are not meant to be a complete rendering of all of the advantages of the various embodiments of the present invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. An apparatus for generating a neutron flux, the apparatus comprising:
a cylindrical holder for holding a plurality of neutron sources;
a cylindrical moderator unit for holding a sample material, wherein a portion of the cylindrical moderator unit is received within the cylindrical holder, wherein the plurality of neutron sources generates the neutron flux for irradiating the sample material; and
a housing unit housing the cylindrical holder and the cylindrical moderator unit, wherein the housing unit reflects a plurality of neutrons generated by the plurality of neutron sources within the housing unit.

2. The apparatus of claim 1, wherein the cylindrical holder comprises an outer cylinder and an inner cylinder, wherein the plurality of neutron sources are positioned around a periphery of the inner cylinder.

3. The apparatus of claim 1 further comprises a base member supporting the cylindrical holder at an end of the cylindrical holder.

4. The apparatus of claim 2, wherein the cylindrical holder is composed of steel.

5. The apparatus of claim 1, wherein the cylindrical moderator unit comprises a neutron moderator material.

6. The apparatus of claim 2, wherein the cylindrical moderator unit comprises:
a first cylindrical unit comprising the neutron moderator material for moderating the plurality of neutrons generated; and
a second cylindrical unit capable of holding the sample material at an end of the second cylindrical unit, wherein the second cylindrical unit is positioned passing through the first cylindrical unit.

7. The apparatus of claim 6, wherein the cylindrical moderator unit further comprises a third cylindrical unit positioned surrounding the second cylindrical unit and within the first cylindrical unit.

8. The apparatus of claim 6, wherein a portion of the first cylindrical unit and the second cylindrical unit are positioned within the inner cylinder of the cylindrical holder, wherein the plurality of neutrons exposed to the portion of the first cylindrical unit comprises at least one thermal neutron.

9. The apparatus of claim 6, wherein a portion of the second cylindrical unit is positioned within the inner cylinder, wherein the plurality of neutrons exposed to the portion of the second cylindrical unit comprises at least one fast neutron.

10. The apparatus of claim 1, wherein the housing unit comprises a neutron shielding material.

11. The apparatus of claim 1, wherein the housing unit is composed of iron.

12. The apparatus of claim 1 further comprises a releasing unit connected to the housing unit and coupled to the cylindrical moderator unit, wherein the releasing unit releases the cylindrical moderator unit for having the portion of the cylindrical moderator unit within the cylindrical holder.
